(19) United States
(12) Patent Application Publication
(10) Pub. No.: US 2023/0061273 A1
(43) Pub. Date: Mar. 2, 2023

(54) SYSTEM AND METHOD FOR MANAGING PACKAGED DANGEROUS GOODS TRANSPORT COMPLIANCE

(71) Applicant: PACKAGED DANGEROUS GOODS GUIDE PTY LTD, Brunswick West, Victoria (AU)

(72) Inventors: Amanda O'BRIEN, Brunswick West, Victoria (AU); John O'BRIEN, Brunswick West, Victoria (AU)

(21) Appl. No.: 17/799,102

(22) PCT Filed: Apr. 9, 2020
(86) PCT No.: PCT/AU2020/050354

§ 371 Date: Aug. 11, 2022

(30) Foreign Application Priority Data
Feb. 14, 2020 (AU) 2020900427

(51) Int. Cl. G06Q 10/08

(52) U.S. Cl. CPC G06Q 10/0832

(57) ABSTRACT

A computer-implemented system including a computing device including one or more processors configured to receive data with respect to two or more goods proposed to be transported together, the device including a user interface for displaying information, the one or more processors executing computer instruction code that performs a compatibility check based upon parameters of the two or more goods to determine compatibility between the two or more goods, whereby in the event the two or more goods are determined to be compatible for transport, the one or more processors automatically display, on the user interface in real-time, confirmation regarding compatibility of the two or more goods for transport, or in the event at least two of the two or more goods are determined to be incompatible for transport, the one or more processors automatically display, on the user interface in real-time, details of the at least two or more goods that are incompatible.

### CROSS REFERENCE TO RELATED APPLICATION

This application is a U.S. National Stage Application of International Application No. PCT/AU2020/050345, filed Apr. 9, 2020, which claims priority to Australian Application No. 2020900427, filed Feb. 14, 2020, the entire contents of each of which are hereby incorporated by reference.

### BACKGROUND

### Field of the Invention

The present disclosure relates to a system and method for managing compliance associated with the transport of goods. The system and method of the present disclosure finds particular application in managing compliance associated with the transport of packaged dangerous goods.

### Background of the Invention

The storage and transport of incompatible goods by road, rail, air or sea, poses a hazard not only to the individuals involved in transporting such goods, but also to the public. Accordingly, a number of national and international standards and procedures have been devised to educate and inform relevant personnel in the goods transport industry in an attempt to mitigate potential risks and hazards that could arise during the storage and transport of incompatible goods.

However, due to the large variety of goods available for transport and the variations in the chemical composition and physical properties of the different goods, the standards and procedures that have been devised are generally complex and difficult to read and understand.

The complexity of the standards, procedures and expectations of the relevant authorities is also increasing, thereby increasing the difficulty for companies and individuals within the industry to adhere to the standards and thereby act in compliance with same. This is a problem since both companies and individuals may be liable or held personally, financially and/or criminally responsible in the event of an incident, particularly when the company or individual is unable to provide evidence that demonstrates adequate precautions to ensure compliance with industry standards and procedures.

Accordingly, confusion sometimes exists amongst companies and individuals within the goods transport industry with respect to which goods are compatible or incompatible for simultaneous transport.

Additionally, whilst training to understand how to handle, store and transport goods is often available to personnel within the goods transport industry, such training in some jurisdictions is optional, and many industry personnel elect to forego formal training and instead rely upon consulting hardcopy manuals and/or accessing static online information to determine which goods may be safely transported together.

Even when training is mandatory, it is often difficult for industry personnel to maintain currency with respect to the standards and procedures of the industry due to rapid changes in the regulations and guidelines regarding the transport of goods, and therefore, personnel responsible for the simultaneous transport of goods tend to rely once again, on hardcopy manuals and static online information.

However, there are problems associated with hardcopy manuals and static online information. For example, hardcopy manuals tend to lack current information due to frequent updates that occur with respect to regulations and guidelines for the transport of goods. With respect to information available and accessible online, although such information tends to be current, many transport vehicle operators tend to travel on routes where it is difficult, if not impossible, to establish a reliable wireless connection to the internet. Accordingly, such operators are often unable to access online information regarding the relevant and current standards and procedures when attempting to determine if the consigned goods are compatible for simultaneous transport.

Existing systems known to the Applicant are also deficient with respect to their ability to report information relating to goods being transported, e.g. to a depot or authority for quick and easy retrieval of information and auditing purposes. Where for example a driver is involved in an accident and a spillage occurs, it may be vital for information relating to the goods being transported and the compliance of such goods to be provided to relevant parties in a quick and efficient manner. For example, in the case of a vehicle accident / spillage where the driver is nonresponsive due to being injured and exposed to dangerous chemicals, information relating to the goods being transported will be vital information for doctors treating the driver. The compatibility of the goods being transported is also information that crews responsible for cleaning the spill and ensuring others in the vicinity are kept out of harm’s way will find useful. Authorities such as the police may also need to access such information for the purpose of determining whether there has been negligence on the part of the driver or depot. There is clearly a need for a goods transport compliance system to be capable of capturing information relating to goods being transported and automatically reporting such information without the need for manual input by the driver.

Accordingly, there exists a need for a system and method that addresses at least some of the abovementioned problems, or at least provides an alternative to same.

### SUMMARY

In one aspect, the present disclosure provides a computer-implemented system including, a computing device including one or more processors configured to receive data with respect to two or more goods proposed to be transported together, the device including a user interface for displaying information, the one or more processors executing computer instruction code that performs a compatibility check based upon parameters of the two or more goods to determine compatibility between the two or more goods, whereby, in the event the two or more goods are determined to be compatible for transport, the one or more processors automatically display, on the user interface in real-time, confirmation regarding compatibility of the two or more goods for transport, or in the event at least two of the two or more goods are determined to be incompatible for transport, the one or more processors automatically display, on the user interface in real-time, details of the at least two or more goods that are incompatible.

In an embodiment, the compatibility check is performed using a matrix of values. In an embodiment, the compatibility matrix is a 2x2 logical matrix of values based upon the different classifications of dangerous goods.

The matrix may be updated periodically (or as necessary) to ensure the matrix entries are based upon current classifications of dangerous goods, guidelines and industry standards. Updates to the matrix entries may also be implemented as a result of user feedback.

In an embodiment, the matrix is loaded during initialization of the system application. The matrix may be a read-only application

In an embodiment, the matrix and system application are stored on one or more remote servers. Alternatively, or additionally, the matrix may be locally stored on one or more user devices.

In an embodiment, the matrix is manually updated, and the updated matrix stored on one or more remote servers. The computer-implemented system of the present disclosure may automatically install system application updates, or alternatively, a user may manually select the installation of a system application update. For example, a user may receive an email notification of one or more regulation changes which may prompt a user to install a system application update on their computing device.

In an embodiment, the system application update is installed by wireless communication.

In an embodiment, the system application including the matrix of values is stored locally on a user’s computing device. It will be appreciated that this is advantageous in instances where the user is travelling to remote destinations in which wireless communication is unreliable or not possible. By having a locally stored system application on their computing device, the user does not need to rely upon establishing a wireless connection to the one or more remote servers on which the system application and matrix are stored in order to access the system application. In an embodiment, the system automatically installs system application updates as soon as the user’s computing device is able to establish a wireless connection with the one or more remote servers on which the matrix (or updated matrix) is stored.

In an embodiment, the system installs only the updated values and not the entire matrix and updated values. It will be appreciated that by installing only the updated matrix values, the amount of data that is required to be transferred between a remote server and a user’s computing device is minimized thereby increasing processor efficiency and conserving computer resources including network bandwidth. The time required to properly update the data stored locally on a user’s computing device could be critical since the user may only have limited periods of time in which they have connectivity to download updated data.

In an embodiment, a user is able to enter data in relation to goods being transported, or goods proposed to be simultaneously transported, or a combination of both, to determine whether two or more of the goods are compatible for simultaneous transport using the system application of the present disclosure.

The data received may relate to any one or more of a United Nations (UN) code (a four-digit number that identifies dangerous goods, hazardous substances and articles such as explosives, flammable liquids, toxic substances etc., in the framework of international transport), a load amount/weight and/or or data relating to any other dangerous goods classification system.

In an embodiment, the one or more processors are in communication with one or more external electronic display devices operable to receive instructions from the one or more processors to display information relating to the goods being transported. It will be appreciated that such external electronic devices may be located at the premises of one or more third parties or responsible authorities, for example, the operations manager of the transport company.

In an embodiment, the one or more processors are in communication with one or more external printing devices operable to receive instructions from the one or more processors to print information relating to the goods being transported. The printed information may be in the form of a sign, that is to be affixed to a vehicle in which the goods are to be, or are being, transported. In an embodiment, the system application is able to automatically print an appropriate sign to be displayed on a transport vehicle based upon the goods being transported.

In an embodiment, a user is able to take a photograph of the good(s) being transported, or proposed to be transported, for goods identification purposes and compliance. The system application may then use optical recognition techniques to determine the type and classification of the goods being transported, or proposed to be transported.

In an embodiment, the system application automatically provides a user with feedback and/or action prompts based upon the outcome of the compatibility check. For example, the system may prompt the user to add and/or remove one or more good(s) or items from a transport vehicle prior to transport of same.

In an embodiment, the system application automatically provides one or more notifications or alerts to a user based upon the outcome of the compatibility check. For example, the system may provide an alert in the form of a question to the user asking if the transport vehicle is sufficiently equipped to carry the proposed goods, or alternatively, a request that the user confirm the total weight of the consignment complies with the regulations.

In an embodiment, the system automatically generates a report based on the outcome of the compatibility check. In an embodiment, the system automatically saves and stores the report for compliance and auditing purposes. Alternatively, a user may manually save the report. In an embodiment, the report is automatically provided to one or more third parties or responsible authorities. For example, a report generated as a result of a compatibility check conducted by driver of a transport company may be automatically sent to any one or more individuals within the supply chain, for example, the operations manager of the transport company.

In an embodiment, the system application also includes time/calendar functionality which records a date/time stamp with respect to each report generated based on a compatibility check conducted by a user. In this regard, it will be appreciated that such functionality may assi st auditing and compliance investigation. That is, the system according to this embodiment is more able to effectively record a history of compliance/non-compliance.

In an embodiment, the system application also displays emergency information in the form of alerts and/or recommendations in the event of a spillage or accident. Such emergency information may include, for example, emergency procedures which are selected based upon the type of goods being transported. In an embodiment, the emergency information relevant to a particular combination of goods is automatically selected based upon the data entered by the user. In an embodiment, the emergency information is displayed upon user request. Alternatively, the emergency information is automatically displayed on the user computing device upon the user selecting an emergency setting.

In an embodiment, upon receiving a user request for the display of emergency information or the user selecting an emergency setting, the system application automatically notifies relevant authorities, including, for example, local fire and police authorities, environmental protection authorities and safety authorities, and sends a list of goods being transported and/or the relevant emergency information pertaining to the particular combination of goods being transported to such authorities. In an embodiment, the system application is also able to automatically determine and send a location of the incident, accident and/or emergency to the relevant authorities by the use of Global Positioning Satellite (GPS) co-ordinates associated with the transport vehicle and/or the user device on which the system application is installed.

In an embodiment, the transport of the goods is by road transport. However, the present disclosure also encompasses managing compliance associated with the storage and transport of goods by alternative modes of transport, including rail, air or sea.

In another aspect, the present disclosure provides a computer-implemented method including, receiving, by a computing device including one or more processors, data with respect to two or more goods proposed to be transported together, performing, by the one or more processors, a compatibility check based upon parameters of the two or more goods to determine compatibility between the two or more goods, the device including a user interface for displaying information, wherein, in the event the two or more goods are determined to be compatible for transport, automatically displaying in real-time, on a user interface of the computing device, confirmation regarding compatibility of the two or more goods for transport, or in the event at least two of the two or more goods are determined to be incompatible for transport, automatically displaying in real-time, on the user interface, details of the at least two or more goods that are incompatible.

In another aspect, the present disclosure provides a computer-readable medium having a plurality of instructions executable by a one or more processors of a computing device to perform the steps of, receiving, by a computing device including one or more processors, data with respect to two or more goods proposed to be transported together, performing, by the one or more processors, a compatibility check based upon parameters of the two or more goods to determine compatibility between the two or more goods, the device including a user interface for displaying information, wherein, in the event the two or more goods are determined to be compatible for transport, automatically displaying in real-time, on a user interface of the computing device, confirmation regarding compatibility of the two or more goods for transport, or in the event at least two of the two or more goods are determined to be incompatible for transport, automatically displaying in real-time, on the user interface, details of the at least two or more goods that are incompatible.

### BRIEF DESCRIPTION OF THE DRAWINGS

The invention will be explained in more detail with reference to the drawings.

FIG. 1 illustrates an exemplary system for managing goods transport compliance in accordance with an embodiment of the present disclosure.

FIG. 2 illustrates an exemplary flow diagram of a process that enables a user to download an application for interacting with the system illustrated in FIG. 1.

FIG. 3 illustrates an exemplary flow diagram of a process that enables a user to create a load report and recording goods being loaded onto a vehicle.

FIG. 4 illustrates an exemplary flow diagram of a process that enables the user to add additional goods to the load report and being alerted to restrictions and other requirements and signage for display.

FIG. 5 illustrates an exemplary flow diagram of a process that enables a user to be notified when two or more goods proposed to be transported are determined to be incompatible.

FIG. 6 illustrates an exemplary flow diagram of a process that enables the user to provide the load report to a depot.

FIG. 7 illustrates an exemplary flow diagram of a process that enables a user to receive information and notify relevant parties when a vehicle transporting goods has been involved in an accident.

### DETAILED DESCRIPTION

The present disclosure relates to at least a computer-implemented system and method for managing goods transport compliance. The system and method involves the use of a recordal and transmission device, such as a mobile device (30), to receive data with respect to two or more goods (50A, 50B, 50C) proposed to be transported together, the recordal and transmission device (30) including at least a user interface for displaying information, the device (30) further including one or more processors configured to perform a compatibility check based upon parameters, including for example the goods labelling (55A, 55B, 55C) associated with the two or more goods (50A, 50B, 50C), wherein in the event the two or more goods are determined to be compatible for transport together, the user interface is caused to automatically display, in real-time or near real-time, confirmation regarding compatibility of the two or more goods for transport. In the event at least two of the two or more goods are determined to be incompatible for transport together, the user interface is caused to automatically display in real-time details of the identification of the at least two of the two or more goods that are incompatible.

As an example, the compatibility check may be based upon parameters included in a 2x2 logical matrix of values in which the values within each of the matrix cells indicate the compatibility of two dangerous goods based on a dangerous goods classification system as follows:
Class 1: Explosives
   Division 1.1: Substances and articles which have a mass explosion hazard
   Division 1.2: Substances and articles which have a projection hazard but not a mass explosion hazard
   Division 1.3:Substances and articles which have a fire hazard and either a minor blast hazard or a minor projection hazard or both
   Division 1.4: Substances and articles which present no significant hazard; only a small hazard in the event of ignition or initiation during transport with any effects largely confined to the package
   Division 1.5: Very insensitive substances which have a mass explosion hazard
   Division 1.6: Extremely insensitive articles which do not have a mass explosion hazard
Class 2: Gases
   Division 2.1: Flammable gases
   Division 2.2: Non-flammable, non-toxic gases
   Division 2.3: Toxic gases
Class 3: Flammable Liquids
Class 4: Flammable Solids; Spontaneous Combustibles; “Dangerous When Wet” Materials
   Division 4.1: Flammable solids
   Division 4.2: Substances liable to spontaneous combustion
   Division 4.3: Substances which, in contact with water, emit flammable gases
Class 5: Oxidizers; Organic Peroxides
   Division 5.1: Oxidizing substances
   Division 5.1: Organic peroxides
Class 6: Toxic Substances; Infectious Substances
   Division 6.1: Toxic substances
   Division 6.2: Infectious substances
   Class 7: Radioactive Material
Class 8: Corrosives
Class 9: Miscellaneous Dangerous Goods

Accordingly, the 2x2 logical matrix in this example may define a series of rows and columns in which each row and column are headed by a particular category (i.e., a Class or Class Division) as indicated above. The rows and columns may also include additional goods that may be transported but don’t necessarily belong to a Class, including, for example, Food & Food empties and Fire Risk Substances. The compatibility between two offsets of dangerous goods in this example may be indicated by either a “YES” or “NO” value, wherein a value of “YES” indicates the two offsets of dangerous goods are able to be safely loaded in the same vehicle or freight container whereas a value of “NO” indicates the two sets of dangerous goods are not able to be safely loaded in the same vehicle or freight container.

As an example, since a dangerous good in Division 2.3 (Toxic Gases) is not compatible for storage and transport with a dangerous good in Class 3 (Flammable Liquids), the matrix cell defined by the intersecting row and column that correspond, respectively, with each of these dangerous goods would indicate a value of “NO”.

As another example, since a dangerous good defined in Class 3 (Flammable Liquids) is compatible for storage and transport with a dangerous good in Class 6 (Toxic Substances; Infectious Substances), the matrix cell defined by the intersecting row and column that correspond, respectively, with each of these dangerous goods would indicate a value of “YES”.

The device (30) may be configured to perform the abovementioned actions through use of a software application (20) installed on the user device (30), for use by a user (10). The reader will appreciate that the use of the application (20) by user (10) in a transport environment in which user (10) is responsible for transporting potentially dangerous goods (50A, 50B, 50C), enables real-time notification to the user (10) regarding which specific goods, amongst the plurality of goods (50A, 50B, 50C) proposed to be transported together, are incompatible, i.e. not to be transported together pursuant to a regulation. In a practical sense, the reader will appreciate that the solution according to the present disclosure facilitates management of goods transport in that it provides real-time feedback to users (10) required to carry or store packaged dangerous goods, for example, in that the application (20) is an easy to use tool that enables the user to decide whether to pick up, pack, store or transport mixed packaged loads safely, and may assist individuals and companies to remain safe, compliant and efficient.

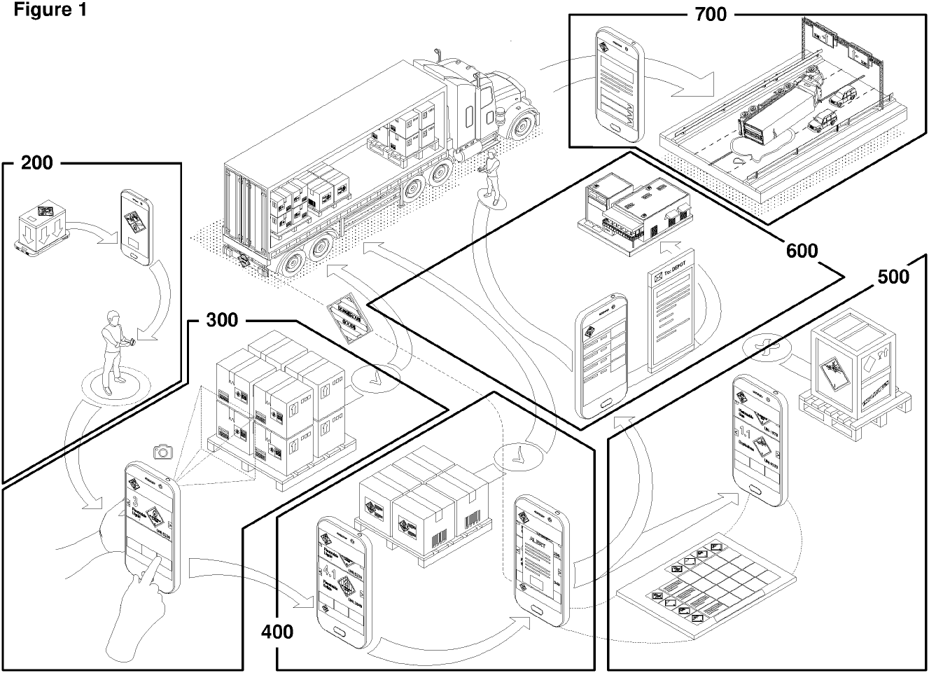

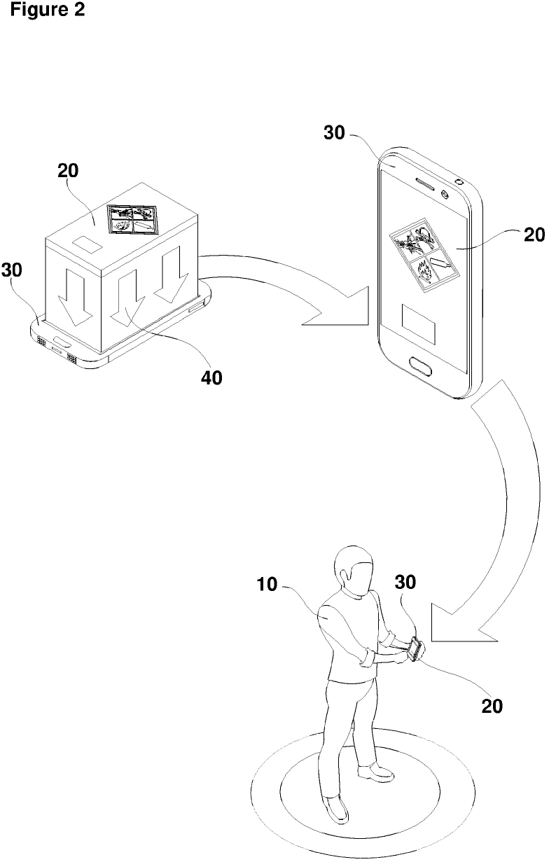

The reader is now directed to FIG. 1 which provides an overview of the system and method of the present disclosure including the use of a device, which in the example shown is a mobile device (30) where each of areas (200), (300), (400), (500), (600) and (700) are expanded in FIGS. 2, 3, 4, 5, 6 and 7 respectively.

In particular, FIG. 1 is divided into areas including area (200) which shows the user (10) downloading and installing the software application (20), area (300) which shows the user (10) creating a load report (70) and recording the goods being loaded onto a vehicle (60), and area (400) which shows the user (10) adding additional goods to the load report, being alerted (90) to any restrictions and other requirements in order to legally transport or dispatch the goods, and being advised (120) of the signage that should be displayed on the vehicle (60). Furthermore, area (500) shows an embodiment wherein the user (10) adds a particular good (50C) that results in a determination that the combination of the particular good (50C) is incompatible with one or both of the other goods (50A, 50B) through use of a reference matrix (1 10), area (600) shows the user (10) providing the load report to their company or depot (150) prior to transportation, and area (700) relates to a situation where the vehicle (60) transporting the goods has been involved in an accident/spill.

FIG. 2 shows in greater detail the area (200) from FIG. 1. In particular, FIG. 2 shows a user (10), who may be a goods delivery driver associated with company or depot (150), installing an application (20) on their mobile device (30). As will become apparent, the application (20) is responsible for receiving or accessing data relating to goods proposed to be transported, and processing such data to determine which goods are compatible and/or incompatible, for example where the goods may be dangerous goods and where regulations provide that a particular combination of dangerous goods should not be transported together. In an alternate embodiment, rather than the processing being undertaken by a processor associated with the mobile device (30), the processing may be undertaken at a remote server (not shown) wherein data received at the device (20) is uploaded to the server, and wherein an output from the processing is transmitted to the device (30) for display to user (10).

The process of installing the application (20) onto the user device (30) according to an embodiment is identified under reference 40 in FIG. 2, and registering to use the application (20) may require a user (10) to enter certain details including name, position within the company, and preferred user name and password. Logging into the application (20) may also require a user (10) to enter certain credentials corresponding to their registration details. A similar registration and login process may also be required for administrators, such as users located at the company or depot (150).

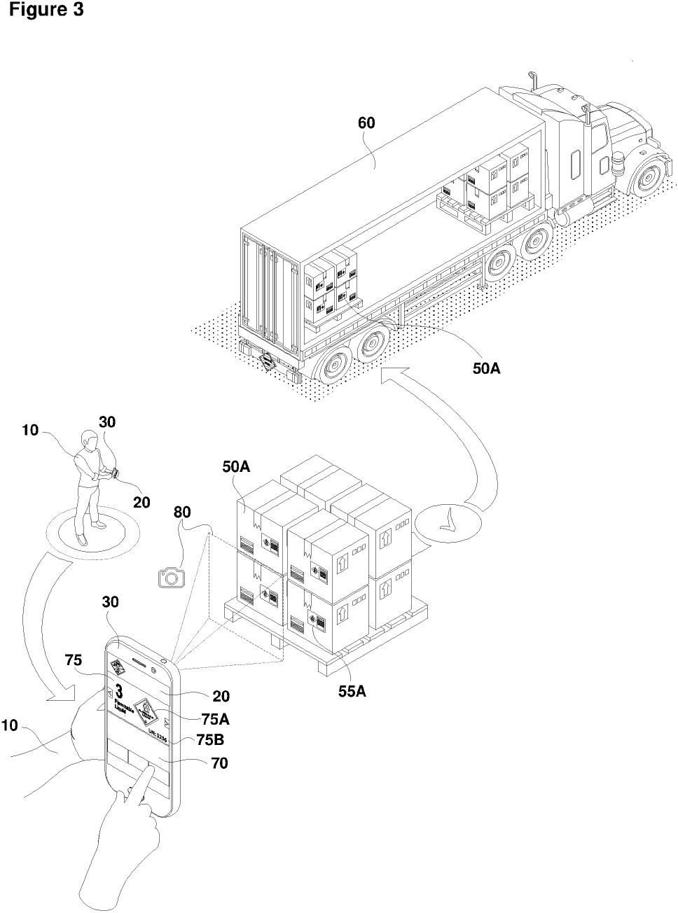

FIG. 3 shows in greater detail area (300) of FIG. 1. In particular, FIG. 3 demonstrates an embodiment in which a user (10), being the driver of a vehicle (60) for transporting goods, is requested to load certain goods (50A) onto the vehicle (60) and wherein the goods (50A) have associated labelling (55A). Using application (20) on the user’s mobile device (30), the user (10) is able to create a new load report and record the goods (50A) being loaded onto the vehicle (60). Accordingly, a user (10) can open the application (20) on their device (30), create a load report (70) wherein the load report captures the dangerous goods being carried. In the embodiment shown in FIG. 3, a listing of pre-defined goods are stored, for example in read-only application storage, and accessible using application (20), and a list of these selectable goods may be presented to the user (10). Rather than listing the name of the goods, the application (20) may list depictions of the goods labelling (e.g. 55A) to enable more efficient visual matching of labels rather than the goods themselves. Updating the goods data base may be achieved through the application (20), for example during initialization of the application from read-only application storage. Alternatively, there may be remote storage of such information where the application (20) is configured to synchronise with a remote server (not shown) in order to regularly update. The labelling (e.g. 55A) may be presented to the user in a scrollable carousel, but other goods selection means are possible.

Accordingly, when the user (10) is confronted with goods (50A) to be transported, the user (10) may read the labelling associated with the goods (55A), then open application (20) in order to locate the specific goods (50A) and/or the specific labelling (55A). In the case of dangerous or hazardous substances, the goods may have an associated United Nations (UN) code which is a unique four-digit code that makes it possible to identify such substances. An example of this code (75B), associated with goods labelling (75A) reflective of “Category 3 Flammable Liquid”, is displayed on the interface of the device (30) shown in FIG. 3. The user (10) may be requested to enter the UN code in addition to a dangerous goods classification (e.g. for the purpose of verifying the selected good), or instead of (e.g. where a particular label cannot be located), manually selecting a label (75A). Such dangerous goods classifications whether alone or in combination with U N codes may also be used to identify articles other than dangerous goods, such as explosives and toxic substances. In this regard, the present disclosure is not intended to be limited to the transport of solely dangerous goods. There may be scenarios where it is merely preferable for two different goods not to be transported together, irrespective of whether they are dangerous or not. The present disclosure may facilitate transport management by identifying goods that are incompatible for transport. Further, transport is not intended to be limited to road transport and may further include transport by sea or air.

FIG. 3 also shows, according to an embodiment, use of a camera (80) associated with mobile device (30) which may be used by the user (10) to take a photo of the goods proposed to be transported and/or labelling associated therewith. For example, a photo may be requested for the purpose of verifying the good selected by the user when creating a load report. Any information uploaded by the user, including a photo, UN code, etc, may form part of a load report (70).

Once the goods (50A) are added to the report, the report may be saved by the user, e.g. manually, or the application (20) may be programmed such that the report is automatically saved at regular intervals or at particular stages of transport. Saving a report may also automatically cause the report to be transmitted to another user, via a network for example, such as an administrator or other personnel located at the company or depot (150). Causing such reports to be transmitted to another party need not be on the basis of a user saving the report, but could occur on any other basis, including by programming the application to provide automatic reporting (without user input) at predetermined times. By doing so, the company or depot (150) or any authority has the ability to maintain a record of the driver, the goods picked up, details regarding compliance, the pick up location (i.e. the location from which certain goods were picked up), and a date and time of pickup. Recording a date and time stamp for recorded transactions may also be achieved utilizing the clock functionality of a mobile device, for example.

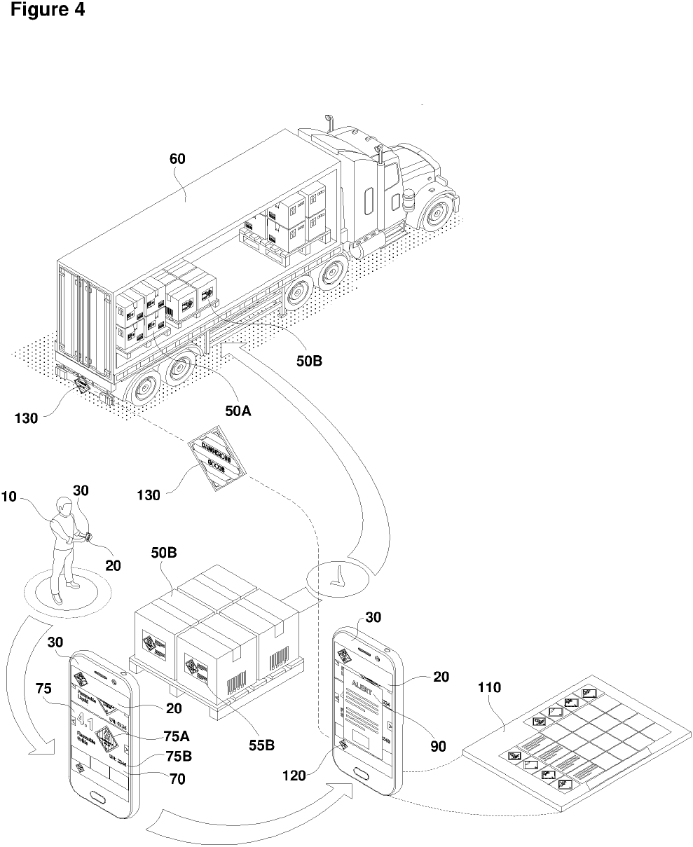

At the same or at an alternate pick up location, the user (10) may be required to add a second load of goods (50B) onto the same vehicle (60) as shown in FIG. 4, which depicts in greater detail area (400) of FIG. 1. It will be appreciated that the goods (50B) are different to the previously loaded goods (50A) and hence have different labelling (55B). Once again, when the user (10) is requested to load the second set of goods (50B), the user may search for and select corresponding labelling (75A) using the application (20) and/or may enter UN code (75B) associated with the second set of goods (50B).

Depending on the type of good that has been loaded, the user (10) may receive notifications or alerts (90) via the mobile device (30) whereby the user (10) may be presented with questions and/or recommendations depending on the load being transported and/or the combination of goods being transported. For example, if the first load of goods (50A) contains “Category 3 Flammable Liquids”, then as soon as those goods are selected by the user in the application (20), an alert (90) may be displayed requesting that the user confirm that truck gates are correctly fitted, that appropriate signage is present on the vehicle (60), and that the vehicle (60) is equipped with an appropriate emergency procedure guide (EPG). Such a notification may also state that the driver (10) is responsible for ensuring that the weight and total weight of the load complies with regulations corresponding with the particular jurisdiction. Such notifications and/or alerts may be generated by configuration of the application (20) to input data associated with good(s) proposed to be loaded onto the vehicle into a reference matrix (110) for processing, and wherein the alert and/or notification constitutes one of the possible outputs of the reference matrix (110).

Another output from the reference matrix (110) may be in the form of a signage indication (120) which is displayed by the user device (30) once a good (or goods) are selected by the user (10). The signage indication indicates to the user (10) what signage they need to display on the vehicle (60) transporting the goods, as shown by example in FIG. 4. According to an embodiment, the application (20) may link to other devices such as a printing device (not shown) and provide instructions to print the relevant sign (130) for subsequent attachment to the rear of the vehicle. Alternatively, the vehicle (60) could be equipped at its rear with an electronic sign (not shown) configured to wirelessly receive instructions from the device (30), e.g. using Bluetooth connectivity, to update a sign depicted on the electronic sign to enable display of the correct sign associated with the good(s) being transported.

The reference matrix (110) that stores or has access to the transportation requirements and safety information for all listed dangerous goods, is also be programmed to determine and output a compatibility of two or more goods being transported or proposed to be transported, e.g. the compatibility to transport a given dangerous good with one or more other dangerous goods. Accordingly, in addition to providing notifications, such as signage indication (120), and alerts, the application (20) causes the device (30) to display compatibility information to the user (10). In the example shown in FIG. 4, the two loads (50A) and (50B) are determined to be compatible goods, i.e. compatible for transport together in the same vehicle (60).

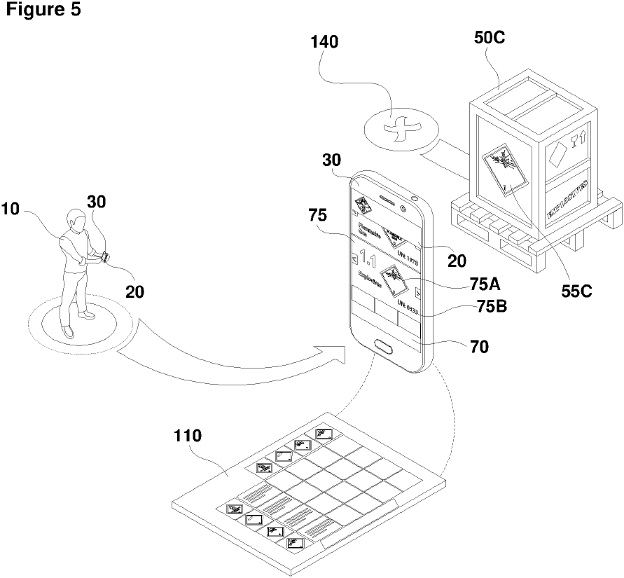

However, there may be instances where goods are determined to be incompatible, as shown in FIG. 5 which depicts area (500) of FIG. 1 in greater detail. FIG. 5 shows a third set of goods (50C) proposed to be loaded and transported, the third goods (50C) including labelling (55C). The user (10) may again edit the load report, in a similar manner to when adding the second set of goods (50B), by searching for and selecting the third set of goods (50C). In particular, the user may select the relevant sign (75A) using the application (20) and/or the relevant UN code (75B). The selection of same, when determined via the reference matrix (110) to be incompatible with either one or both of goods (50A) and (50B), causes the device (30) to indicate to the user (10) that there is an incompatible or unsafe combination (140). In other words, where the combination of certain dangerous goods is unsafe, the user (10) will be warned, in real-time or near real-time, that the load is unsafe and cannot be carried together, i.e. should not be loaded onto the same vehicle (60) with one or both of the other goods (50A, 50B). Receipt of such a notification may cause the user (10) to refuse to load the goods (50C), to remove one or both of the loaded goods (50A, 50B), or at least communicate with his or her superiors regarding how to address the incompatibility.

There may be scenarios where up to five or more different types of goods may be transported using a single vehicle (60), where such goods are picked up from the same or different locations, and the skilled addressee would appreciate that being able to utilize a mobile device (30) to receive instantaneous (in or near real-time) feedback in relation to the compatibility of such goods provides the user with the ability to remove or refuse to load one or more of the goods in order to ensure that the load being carried by the vehicle is safe for transport.

In an embodiment, details of at least two goods that are incompatible to the exclusion of the remaining compatible good(s) are selected by the application processor for display. The skilled addressee would appreciate that by only displaying the goods that are incompatible, the user can more quickly and efficiently address potential issues by removing one or both of the incompatible goods without being required to spend additional time determining which of the multiple sets of different goods are incompatible and hence candidates for removal from the vehicle (60).

The application (20) may also cause prompts to be generated and displayed to the user, including a prompt to add/remove certain goods from the vehicle. Such recommendations need not only be based on the compatibility of goods being processed, but on additional data. For example, the application (20) may store or have access to travel route data associated with the company or depot (150) who employ multiple drivers, and the recommendations may be further based on the ability for incompatible goods to be collected by other drivers about to leave the depot or already in transit along a similar transport route, for example.

Where the types of goods being picked up from particular locations and transported to other locations can be determined prior to departure of the driver from the depot, it will be appreciated that the application (20) can be used by personnel at the depot (150) responsible for planning each driver’s travel route(s) over a particular time period (e.g. day or week). In this way, travel routes may be planned for multiple drivers in a manner that prevents or at least minimizes the occurrence of incompatible goods being transported together.

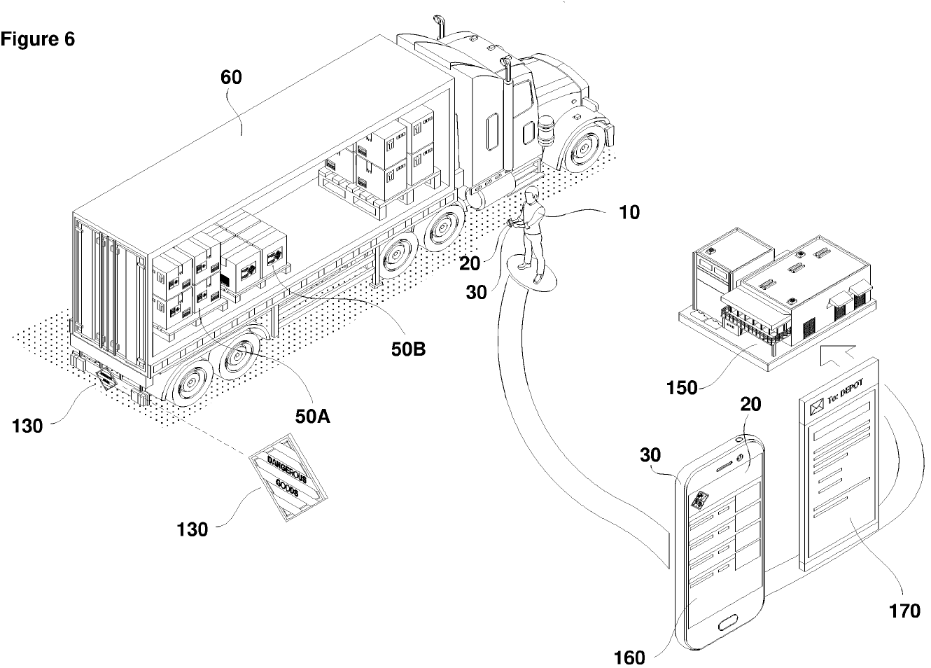

FIG. 6 shows in greater detail area (600) of FIG. 1. In particular, FIG. 6 shows the user (10) providing the load report to their company or depot (1 50) just prior to transportation, e.g. via email and/or SMS, for compliance purposes. As mentioned earlier, this step may be manual or automatic. Such information may be subsequently audited for compliance purposes, and it will be appreciated that the data once captured can be easily reviewed. For example, the data can be sorted by relevant categories such as “user”, wherein a load report listing (160) may be generated or filtered to display all reports created by a particular user, and in which it will be easily ascertainable whether certain loads were transported by the user in a safe (compatible) or unsafe (incompatible) manner. In the case of automatic pushing of information back to the company or depot (150) on a regular basis, one benefit associated with such an automated process may be that whenever an unsafe (incompatible) load is registered, an alert may be provided to personnel at the company or depot (150) who may then elect to contact the particular driver who has (intentionally or non-intentionally) elected to transport incompatible goods. An example of email report (170) that could be transmitted to the company or depot (150), in which the dangerous goods being carried (50A, 50B) and additional information are detailed, is also shown in FIG. 6.

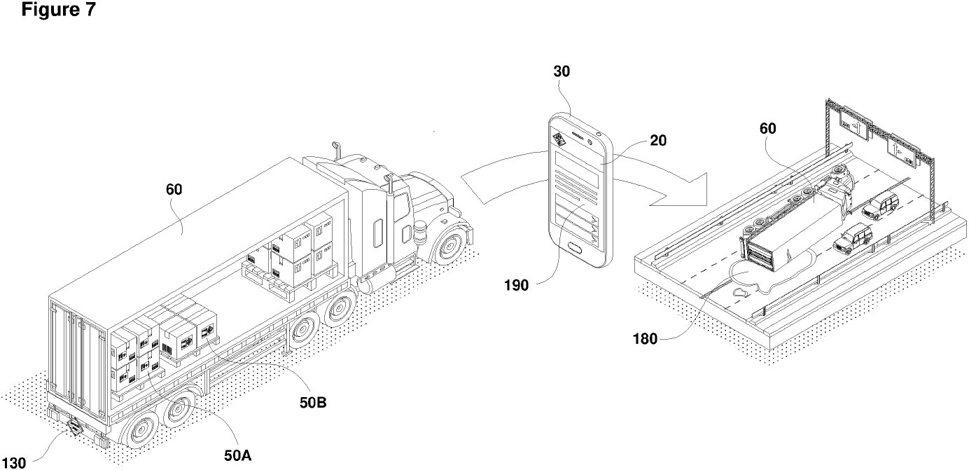

FIG. 7 shows in greater detail area (700) of FIG. 1, and demonstrates a situation where the vehicle (60) transporting dangerous goods has been involved in an accident where a spillage (180) has occurred. The user (10) may, via mobile device (30), use the application (20) to not only report such an accident or spillage (180), but further to receive information and/or recommendations regarding what to do in the event of the particular spillage or leak, which recommendations may be dependent upon the actual goods being transported. The application (20) could also be used to notify emergency services and, if required, the Environmental Protection Agency (EPA), and the previous reporting of goods being transported for compliance will be useful in providing such authorities with quick access to relevant data for the purpose of addressing any emergency or environmental concerns. For example, the company or depot (150) may recognise that particular goods (50A, 50B) have been spilt, and feedback via the application (20) may be in the form of an emergency procedure guide selected based upon the particular goods that have been spilt. An example of an accident information screen (190) is shown in FIG. 7.

There may also be situations where the driver is injured and non-responsive after being involved in an accident and exposed to dangerous chemicals which have been spilled. In this situation, it is vital for information relating to the driver, the goods being transported and the compliance of such goods to be provided to relevant parties in a quick and efficient manner. As mentioned earlier, transmitting reports that have been captured on the user device to a depot or other relevant authority may occur automatically, which means that even if the driver is unable to physically send a report, such authorities may continue to be provided with relevant and up to date information. For example, information relating to the goods being transported and the chemicals to which the driver has been exposed will be vital information for doctors treating the driver. The compatibility of the goods being transported, including any effects associated with two or more spilled goods coming into contact, is also information that crews responsible for cleaning the spill and ensuring others in the vicinity are kept out of harm’s way will find useful. Authorities such as the police may also need to access such information for the purpose of determining whether there has been negligence on the part of the driver or depot.

The skilled addressee would now appreciate the benefits and advantages associated with the system and method of the present disclosure which enables the provision of instantaneous feedback to a user, and other relevant personnel, regarding specific goods being transported or proposed to be transported and any incompatibilities with respect to such goods. Such a system and method is applicable in any industry in which personnel are required to carry or store packaged dangerous goods, for example. The solution facilitates individuals and companies to remain safe, compliant and efficient in that it enables such personnel to decide whether to pick up, pack, store or transport mixed package loads safely. The type of personnel who may find such a device useful include, but are not limited to, truck drivers, warehouse managers, store persons, loaders/forklift drivers, operations manifest staff (to assist them to confirm the loads they are allowed to organise for drivers, or when planning driver travel routes), sales staff (to help communicate with customers when quoting), inbound/outbound operations (to help confirm whether a truck is safe to enter or exit a particular premises), government authorities, government bodies, Environmental Protection Agency (EPA), police, WorkSafe, global companies, and emergency services.

Since the reference matrix (110) is responsible for receiving and/or storing data, and processing same in order to provide relevant outputs as described above, it wall be appreciated that the reference matrix is configured to also be updated such that data accessed and/or stored thereby is up to date and in compliance with the most current regulations. By providing a single platform upon which all industry standards, procedures and guides may be coupled to provide real-time personalised feedback according to particular goods being transported, at least the technical problem of how to use a device to manage goods transport compliance is addressed.

The user device (30) could be a tablet computer, a smartphone, a laptop computer, a desktop computer, or another type of computing device. The user device (30) may include a display that provides an interface for the user to input and/or view information. For example, a user could interact with the device using a program run on a laptop computer, such as a text-based chat program, a voice-based communication program, and/or a video-based communication program. Alternatively, in some cases, the user device (30) could be a telephone (e.g., a landline, cell phone, etc.).

The matrix and associated data may be stored in read-only application storage associated with application (20), or alternatively at a remote server (not shown), which may be in the form of a single computer, particular computing resources of a single computer, a plurality of computers communicating with one another, or a network of remote servers (e.g. cloud).

The user device (30) may communicate with the server (not shown) for the above purposes or for the purpose of receiving updates over a network. In some embodiments, the network may be a wide segment network (“WAN”), e.g., the Internet. In other embodiments, the network may be a local segment network (“LAN”). For example, in a more remote location far from a metropolitan segment, the Internet may not be available. In yet other embodiments, the network may be a combination of a WAN and a LAN. In embodiments where the mobile device (30) is a phone (e.g., a landline or a cell phone), the communication may pass through a telecommunications network and/or a wide segment network.

It will be appreciated by persons skilled in the relevant field of technology that numerous variations and/or modifications may be made to the invention as detailed in the embodiments without departing from the spirit or scope of the invention as broadly described. The present embodiments are, therefore, to be considered in all aspects as illustrative and not restrictive.

Throughout this specification and claims which follow, unless the context requires otherwise, the word “comprise”, and variations such as “comprises” and “comprising”, will be understood to imply the inclusion of a stated feature or step, or group of features or steps, but not the exclusion of any other feature or step or group of features or steps.

1-20. (canceled)

21. A computer-implemented system including:
a computing device including one or more processors configured to receive data with respect to two or more goods proposed to be transported together, the device including a user interface for displaying information;
the one or more processors executing computer instruction code that performs a compatibility check based upon parameters of the two or more goods to determine compatibility between the two or more goods,
wherein the compatibility check is performed using a matrix of values stored locally on the computing device;
wherein a second matrix of values is stored in a database located on a server located externally to the computing device, the server being in communication with the one or more processors of the computing device such that the matrix of values stored locally on the computing device are automatically updated upon the computing device establishing a wireless connection with the server; and
wherein the locally stored matrix of values is updated by installing only the values of the second matrix of values which have been updated on the remote server; whereby:
in the event the two or more goods are determined to be compatible for transport:
the one or more processors automatically display, on the user interface in real-time, confirmation regarding compatibility of the two or more goods for transport; or
in the event at least two of the two or more goods are determined to be incompatible for transport:
the one or more processors automatically display, on the user interface in real-time, details of the at least two or more goods that are incompatible.

22. A computer-implemented system according to claim 21, wherein the one or more processors are in communication with one or more external electronic display devices associated with a vehicle transporting the two or more goods operable to receive instructions from the one or more processors to display information relating to the goods being transported.

23. A computer-implemented system according to claim 21, wherein the one or more processors are in communication with one or more external printing devices operable to receive instructions from the one or more processors to print information relating to the goods being transported.

24. A computer-implemented system according to claim 23, wherein the printed information is a sign for display on a vehicle transporting the two or more goods, the one or more printing devices configured to automatically print the sign with the information relating to the goods being transported.

25. A computer-implemented system according to claim 21, wherein the data with respect to two or more goods proposed to be transported together received by the one or more processors includes a photograph of at least one of the two or more goods being transported.

26. A computer-implemented system according to claim 25, wherein the system uses one or more optical recognition techniques to determine the goods being transported from the photograph of the good(s) being transported.

27. A computer-implemented system according to claim 21, wherein the one or more processors execute computer instruction code to cause the user interface to display feedback and/or one or more action prompts on the user device based upon the outcome of the compatibility check.

28. A computer-implemented system according to claim 27, wherein the one or more action prompts displayed instruct, based on the outcome of the compatibility check, regarding the addition and/or removal of one or more of the two or more goods being transported.

29. A computer-implemented system according to claim 21, wherein the one or more processors execute computer instruction code that automatically generates a report including information relating to one or more of:
a driver of a vehicle transporting the two or more goods,
the two or more goods being transported,
an outcome of the compatibility check,
a pickup location of the two or more goods,
a destination location of the two or more goods,
a map route between the pickup and destination location,
a current location of the vehicle,
a date and/or time stamp associated with the report generation.

30. A computer-implemented system according to claim 29, wherein the one or more processors execute computer instruction code to automatically save and store the report for compliance and/or auditing purposes.

31. A computer-implemented system according to claim 29, wherein the one or more processors execute computer instruction code to automatically provide the report to one or more third parties.

32. A computer-implemented system according to claim 31, wherein the report is automatically transmitted, based upon completion of an action or at predetermined intervals, to a device or computing system associated with the one or more third parties, the third parties including one or more of:
a transport depot responsible for managing transport of the two or more goods,
emergency services,
a hospital or health practitioner or GP,
a police department,
environmental protection agency (EPA).

33. A computer-implemented system according to claim 21, wherein the user interface is configured to display information including alerts and/or recommendations in the event of a spillage, incident or an accident, wherein the alerts and/or recommendations are automatically generated based upon the data received with respect to two or more goods being transported together.

34. A computer-implemented system according to claim 21, wherein the current location is determined by the use of Global Positioning Satellite (GPS) co-ordinates associated with the vehicle and/or the computing device associated with the driver.

35. A computer-implemented method including:
receiving, by a computing device including one or more processors, data with respect to two or more goods proposed to be transported together,
performing, by the one or more processors, a compatibility check based upon parameters of the two or more goods to determine compatibility between the two or more goods,
wherein the compatibility check is performed using a matrix of values stored locally on the computing device;
wherein a second matrix of values is stored in a database located on a server located externally to the computing device, the server being in communication with the one or more processors of the computing device such that the matrix of values stored locally on the computing device are automatically updated upon the computing device establishing a wireless connection with the server; and
wherein the locally stored matrix of values is updated by installing only the values of the second matrix of values which have been updated on the remote server;
the device including a user interface for displaying information;
wherein:
in the event the two or more goods are determined to be compatible for transport:
automatically displaying in real-time, on the user interface of the computing device, confirmation regarding compatibility of the two or more goods for transport; or
in the event at least two of the two or more goods are determined to be incompatible for transport:
automatically displaying in real-time, on the user interface, details of the at least two or more goods that are incompatible.

36. A computer-readable medium having a plurality of instructions executable by one or more processors of a computing device to perform the steps of:
receiving, by a computing device including one or more processors, data with respect to two or more goods proposed to be transported together,
performing, by the one or more processors, a compatibility check based upon parameters of the two or more goods to determine compatibility between the two or more goods,
wherein the compatibility check is performed using a matrix of values; stored locally on the computing device;
wherein a second matrix of values is stored in a database located on a server located externally to the computing device, the server being in communication with the one or more processors of the computing device such that the matrix of values stored locally on the computing device are automatically updated upon the computing device establishing a wireless connection with the server; and
wherein the locally stored matrix of values is updated by installing only the values of the second matrix of values which have been updated on the remote server;
the device including a user interface for displaying information;
wherein:
in the event the two or more goods are determined to be compatible for transport:
automatically displaying in real-time, on the user interface of the computing device, confirmation regarding compatibility of the two or more goods for transport; or
in the event at least two of the two or more goods are determined to be incompatible for transport:
automatically displaying in real-time, on the user interface, details of the at least two or more goods that are incompatible.
